(19) United States
(12) Patent Application Publication
(10) Pub. No.: US 2020/0072351 A1
(43) Pub. Date: Mar. 5, 2020

(54) GEARBOX AND PARKING MECHANISM THEROF

(71) Applicant: INDUSTRIAL TECHNOLOGY RESEARCH INSTITUTE, Hsinchu (TW)

(72) Inventors: Po-Wen CHEN, Hsinchu (TW); Li-Te HUANG, Hsinchu (TW); Chia TSAO, Hsinchu (TW); Meng-Ru WU, Hsinchu (TW); Ming-Hsien YANG, Hsinchu (TW); Cheng-Ping YANG, Hsinchu (TW); Jui-Tang TSENG, Hsinchu (TW)

(73) Assignee: INDUSTRIAL TECHNOLOGY RESEARCH INSTITUTE, Hsinchu (TW)

(21) Appl. No.: 16/196,957

(22) Filed: Nov. 20, 2018

(30) Foreign Application Priority Data
Aug. 28, 2018 (TW) 107129943

(51) Int. Cl. F16H 63/34; B60T 1/00; B60T 1/06

(52) U.S. Cl. CPC F16H 63/3433; B60T 1/005; F16H 2061/2869; B60Y 2200/91; B60T 1/062

(57) ABSTRACT

A parking mechanism used in gearbox, including a ratchet pawl and a cam set for driving the ratchet pawl. The cam set includes a shaft, a first and a second cam pivotally engaged with the shaft, wherein the shaft drives the first cam and the second cam to rotate, so as to drive the ratchet pawl to engage with a gear wheel that is pivotally engaged with a shaft member and to stop the shaft member. The cam set as a driving means simplifies the parking mechanism and is easy to be manufactured and disassembled.

### CROSS REFERENCE TO RELATED APPLICATION

This application claims the priority benefit of Taiwan application serial no. 107129943, filed on Aug. 28, 2018. The entirety of the above-mentioned patent application is hereby incorporated by reference herein.

### BACKGROUND

### 1. Technical Field

The present disclosure relates to parking mechanisms, and more particularly, to a parking mechanism that works in conjunction with a gearbox.

### 2. Description of Related Art

Current parking mechanism is not only structurally complex, but also requires high cost in production. Especially, since modern cars have been equipped with more electronic devices, especially in electric cars, elevating the production cost. Therefore, there is a need to reduce the cost from other mechanisms to be competitive in the car market.

Accordingly, an urgent need is required for a solution that addresses the aforementioned issues in the prior art.

### SUMMARY OF THE DISCLOSURE

In view of the aforementioned shortcomings of the prior, the present disclosure provides a parking mechanism, which includes: a ratchet pawl; and a cam set configured for driving the ratchet pawl and including a shaft, a first cam and a second cam pivotally engaged with the shaft, wherein the shaft is configured for driving the first cam and the second cam to rotate.

In an embodiment of the parking mechanism, it may further include a gear wheel engaged with the ratchet pawl.

In an embodiment of the parking mechanism, the first cam is in contact with the ratchet pawl. For example, the contact surface where the first cam is in contact with the ratchet pawl may be divided as a first camber region and a second camber region, and a planar region coupling with the first and second camber regions. Furthermore, the ratio of the radius of the first camber region to the radius of the shaft is between 1 and 3, and the ratio of the length of the planar region and the radius of the shaft is between 1 and 3. Also, the ratio of the radius of the second camber region and the radius of the shaft is between 2 and 4.

In an embodiment of the parking mechanism, it may further include a resilient element disposed between the first cam and the second cam. Further, the first cam and the second cam compress the resilient element, and the first cam triggers the ratchet pawl to create a parking state. For example, the resilient element is a compression spring.

The present disclosure also provides a gearbox, which includes a main body with a baffle block; a ratchet pawl; and a cam set configured for driving the ratchet pawl and including a shaft, a first cam and a second cam pivotally engaged with the shaft, wherein as the shaft drives the first cam and the second cam to rotate, the second cam abuts against the baffle block.

In an embodiment of the gearbox, the abutting surface whereby the second cam abuts against the baffle block is a planar surface.

In an embodiment of the gearbox, the baffle block is configured for stopping the movement of the second cam, which in term stops the movement of the shaft and the first cam.

The present disclosure further provides a gearbox including: a first shaft; a second shaft; a third shaft; a first gear wheel assembly disposed at the first shaft and the second shaft; a second gear wheel assembly disposed at the first shaft and the second shaft; and a transmission mechanism disposed at the second shaft and the third shaft; a ratchet pawl configured for driving or stopping the movement of the third shaft.

In an embodiment of the gearbox, it further includes a cam set and a ratchet pawl, wherein the cam set is configured to drive the ratchet pawl, and the ratchet pawl is configured to drive or stop the third shaft. The cam set includes a shaft, a first cam and a second cam pivotally engaged with the shaft, wherein the shaft drives the first cam and the second cam to rotate.

In an embodiment of the gearbox, the first shaft serves as an input shaft, while the third shaft serves as an output shaft. The ratchet pawl is engaged with the third shaft via a gear wheel.

In an embodiment of the gearbox, it further includes a gear wheel, which is configured for engaging with the ratchet pawl and driving the third shaft.

In an embodiment of the gearbox, a synchronizer is disposed between the first gear set and the second gear set on the first shaft.

In an embodiment of the gearbox, the first shaft, the second shaft and the third shaft are sequentially positioned in parallel.

In an embodiment of the gearbox, it further includes a differential disposed at the third shaft.

The present disclosure further provides a gearbox, including: a first shaft; a second shaft which penetrates through the first shaft; a first gear set disposed at the first shaft; a second gear set disposed at the first shaft; a one-direction thrust bearing disposed at the first gear set; a clutch disposed at the second gear set; a transmission mechanism configured for driving the first gear set or the second gear set; a ratchet pawl engaged with the transmission mechanism; and a cam set engaged with the ratchet pawl, and including a shaft, a first cam and a second cam pivotally engaged with the shaft, wherein the shaft drives the first cam and the second cam to move.

In an embodiment of the gearbox, the first shaft serves as an input shaft, and the second shaft serves as an output shaft.

In an embodiment of the gearbox, the first shaft and the second shaft are coupled such that the first shaft is an outer shaft while the second shaft is an inner shaft.

In an embodiment of the gearbox, it further includes a gear wheel engaged with the ratchet pawl and the transmission mechanism. For example, the transmission mechanism includes a transmission shaft engaged with the first gear set or the second gear set and the gear wheel is engaged with the transmission shaft.

In an embodiment of the gearbox, it further includes a differential disposed at the second shaft to be engaged with the transmission mechanism.

From the above, the gearbox and the parking mechanism of the present disclosure provide the cam set (a shaft with two cams) as a driving means to simplify the parking mechanism, and it can be easily manufactured and dissembled.

Further, the contact surface of the first cam is divided as a first camber region, a planar region and a second camber region, so as to assist the ratchet pawl to make smooth movement in relation to the first cam, thereby reducing any impacts between the ratchet pawl and the first came to prevent mechanical failure of the parking mechanism from occurrence.

Also, the cam set's movement is controlled via the coordination of the second cam and the baffle block.

### BRIEF DESCRIPTION OF THE DRAWINGS

FIG. 1A is a schematic plane diagram of a parking mechanism in accordance with the present disclosure.

FIGS. 1B and 1C are a 3D left view and a 3D right view, respectively, depicting a gearbox in accordance with a first embodiment of the present disclosure.

FIG. 1D is a partially magnified view of FIG. 1A.

FIGS. 2A to 2B are schematic plane diagrams showing the operational process of FIG. 1B.

FIG. 2C is a schematic plane view of FIG. 2B in another state.

FIG. 3 is a schematic view depicting the framework of the gearbox in accordance with a second embodiment of the present disclosure.

FIG. 4 is a schematic view depicting the framework of the gearbox in accordance with a third embodiment of the present disclosure.

### DETAILED DESCRIPTION OF THE EMBODIMENTS

The technical content of present disclosure is described by the following specific embodiments. One of ordinary skill in the art can readily understand the advantages and effects of the present disclosure upon reading the disclosure of this specification. The present disclosure may also be practiced or applied with other different implementations. Based on different contexts and applications, the various details in this specification can be modified and changed without departing from the spirit of the present disclosure.

It should be noted that the structures, ratios, sizes shown in the drawings appended to this specification are to be construed in conjunction with the disclosure of this specification in order to facilitate understanding of those skilled in the art. They are not meant, in any ways, to limit the implementations of the present disclosure, and therefore have no substantial technical meaning. Without affecting the effects created and objectives achieved by the present disclosure, any modifications, changes or adjustments to the structures, ratio relationships or sizes, are to be construed as fall within the range covered by the technical contents disclosed herein. Meanwhile, terms, such as “on”, “in”, “left”, “right”, “a”, and the like, are for illustrative purposes only, and are not meant to limit the range implementable by the present disclosure. Any changes or adjustments made to their relative relationships, without modifying the substantial technical contents, are also to be construed as within the range implementable by the present disclosure.

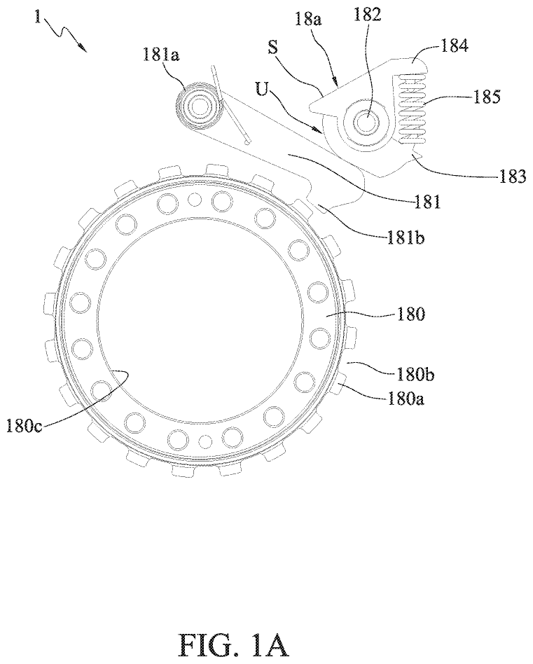

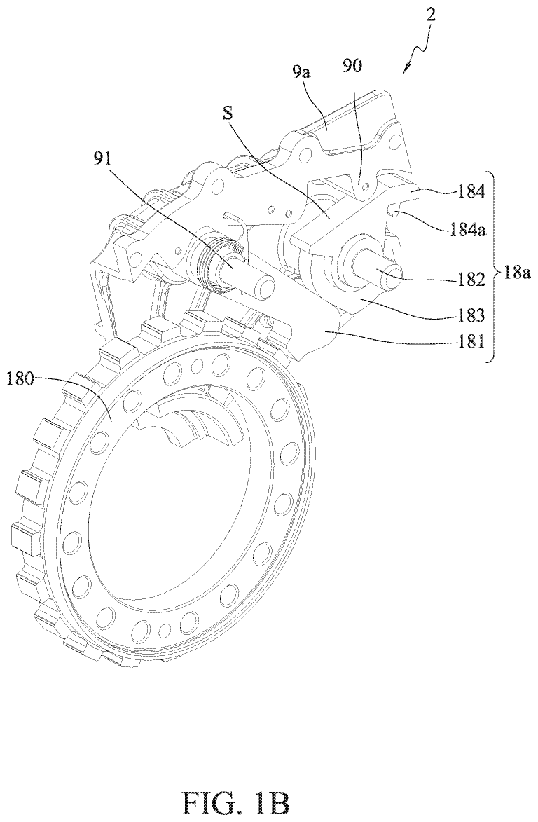

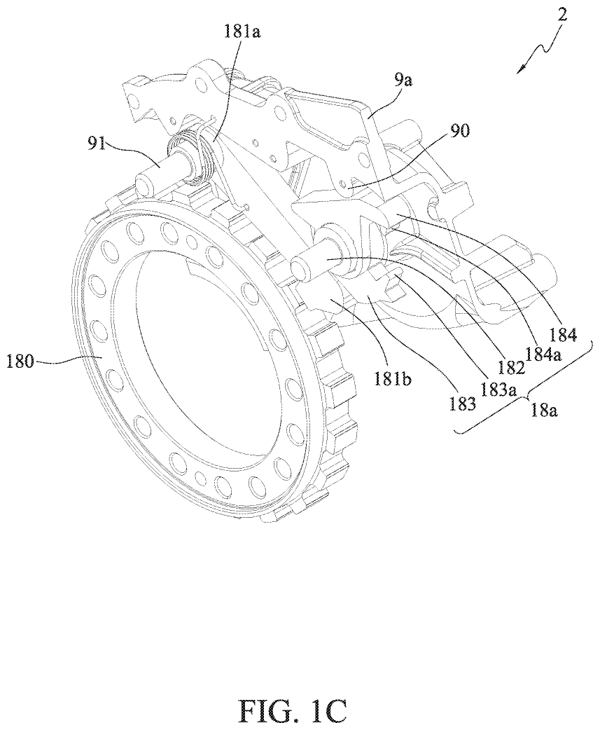

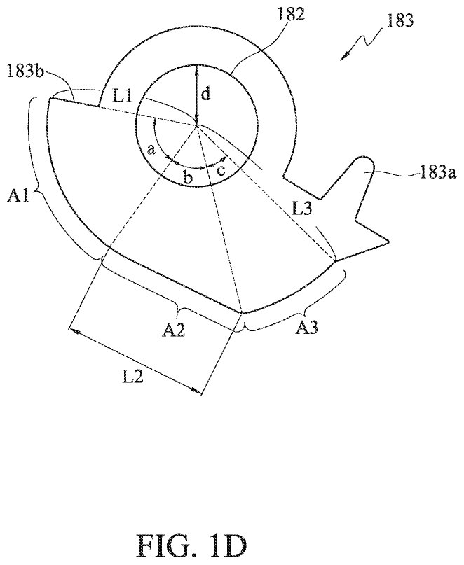

FIG. 1A is a schematic plane diagram showing the parking mechanism 1 in accordance with the present disclosure. FIGS. 1B and 1C are 3D left view and 3D right view, respectively depicting the gearbox 2 in accordance with a first embodiment of the present disclosure.

As shown in FIGS. 1B and 1C, the gearbox 2 includes a main body 9a and the parking mechanism 1, and the parking mechanism 1 includes a gear wheel 180, a resilient element 185, a ratchet pawl 181 and a cam set 18a.

The gear wheel 180 is used for engaging with the ratchet pawl 181 having a plurality of teeth 180a and a groove 180b between adjacent two teeth 180a.

In this embodiment, the gear wheel 180 has a ring shape with a shaft hole 180c at the center for a shaft (not shown) to be inserted therein, such that the gear wheel 180 rotates along with the shaft.

The ratchet pawl 181 is pivotally mounted on the main body 9a of the gearbox 2. In the present embodiment, the pivot end 181a of the ratchet pawl 181 is positioned on the rotation shaft 91 of the main body 9a, and the engaging end 181b of the ratchet pawl 181 is used for engaging the groove 180b of the gear wheel 180.

The cam set 18a is used for engaging with the ratchet pawl 181 to move, and the cam set 18a includes a shaft 182, a first cam 183 and a second cam 184 pivotally mounted to the shaft 182, wherein the shaft 182 engages with the first cam 183 and the second cam 184 to rotate.

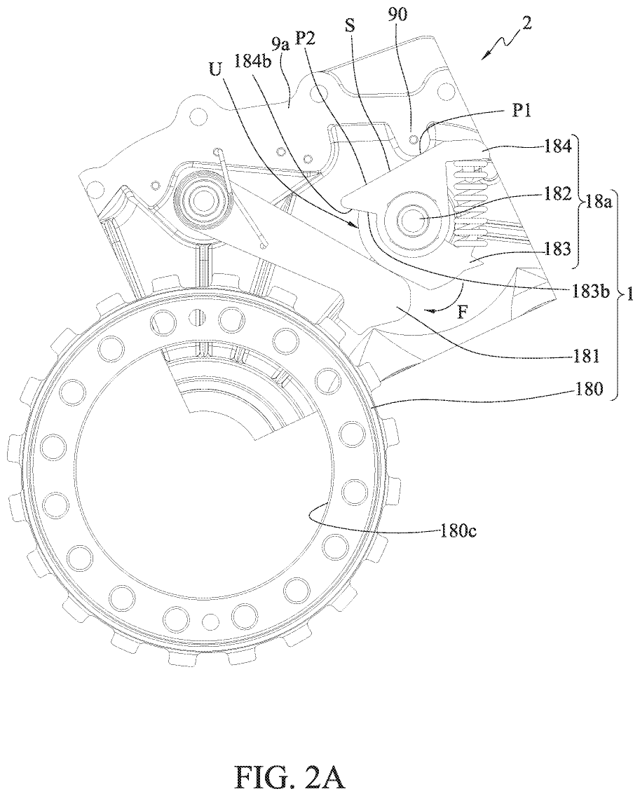

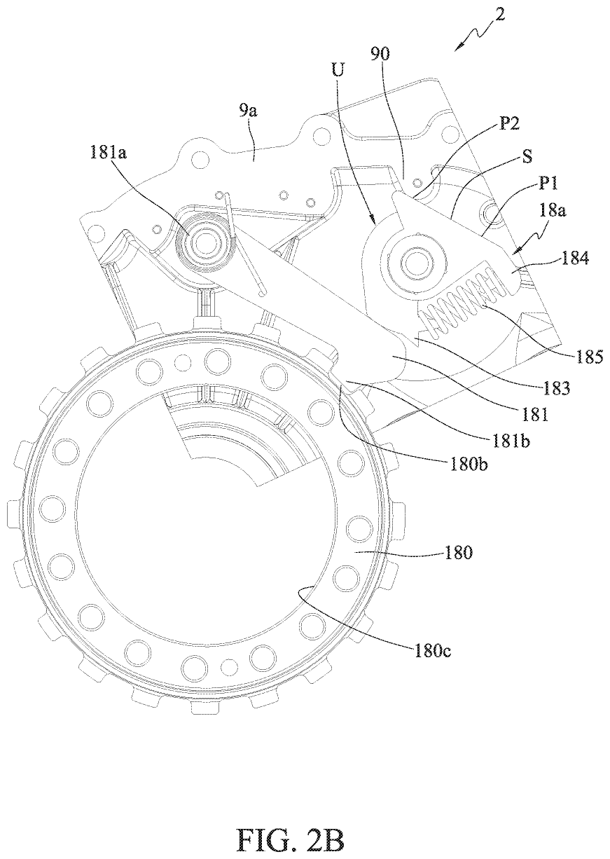

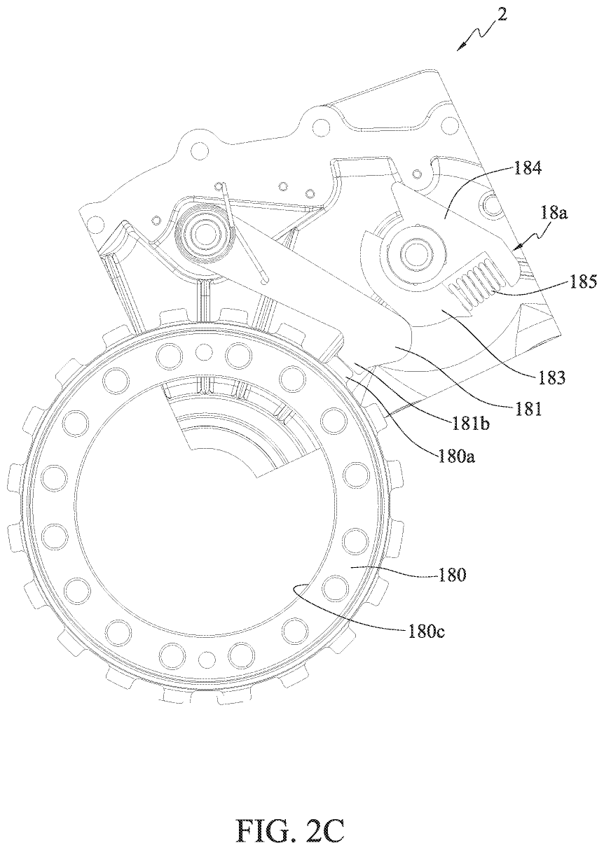

In the present embodiment, the first cam 183 is in contact with one end of the ratchet pawl 181. And, as shown in FIGS. 1D and 2A, the contact surface U of the first cam 183 in contact with the ratchet pawl 181 is divided as a first camber region A1, a second camber region A3 and a planar region A2 positioned between the first and the second camber regions A1, A3. For example, the camber areas of the first and the second camber regions A1, A3 and the planar area of the planar region A2 are designed in accordance with the radian of the shaft 182, wherein the radian a of the first camber region A1 has an angle ranged from 50 to 100 degrees, the radian b of the planar region A2 has an angle of 50 degree, and the radian c of the second camber region A3 has an angle of 50 degree.

As shown in FIG. 1D, the ratio of the radius L1 of the first camber region A1 to the radius d of the shaft 182 is between 1 and 3 (i.e., L1/d=1˜3), the ratio of the length L2 of the planar region surface A2 to the shaft 182 is between 1 and 3 (i.e., L2/d=1˜3), and the ratio of the radius L3 of the second camber region A3 to the radius d of the shaft 182 is between 2 and 4 (i.e., L3/d=2˜4).

The resilient element 185 is disposed between the first and the second cams 183, 184.

In the present embodiment, the resilient element 185 may be a compression spring, where one end thereof is mounted to the pillar 183a of the first cam 183 (shown in FIGS. 1C and 1D) and the other end thereof is mounted to the pillar 184a of the second cam 184 (shown in FIGS. 1B and 1C). The first and the second cams 183, 184 compress the resilient element 185 at a certain motion, and the first cam 183 touches (e.g., pushes) the engaging end 181b of the ratchet pawl 181 such that the engaging end 181b of the ratchet pawl 181 abuts against the gear wheel 180 in such a way that the gear wheel 180 and the shaft in the shaft hole 180c cannot be rotated, and thereby creating a parking state.

The main body 9a of the gearbox 2 has a baffle block 90 to stop the second cam 184.

In the present embodiment, the main body 9a has all the requirement elements required in the gearbox 2. In addition, the baffle block 90 is positioned on a member (such as an actuator) near the cam set 18a.

When the shaft 182 engages with the first cam 183 and the second cam 184 to rotate up to a certain angle, the baffle block 90 will stop the movement of the shaft 182, such that the first cam 183 also stops rotating.

The abutting surface S of second cam 184 abutting against the baffle block 90 is a plane surface.

When the gearbox 2 is in operation, as shown in FIG. 2A, the gear wheel 180 will rotate along with the output shaft (pivotally mounted in the shaft hole 180c) of the gearbox 2. Meanwhile, the ratchet pawl 181 and the gear wheel 180 are set apart or are not in contact with each other. To enter the parking state, the user may use the interlinkage mechanism (not shown) to rotate the shaft 182, wherein the second cam 184 is engaged with one end of the shaft 182, and one end 183b of the first cam 183 abuts against the baffle plate 184b of the second cam 184 to permit the shaft 182 to rotate along with the first and the second cam 183, 184 (as indicated by the direction F in FIG. 2A), triggering the first cam 183 to downwardly push the engaging end 181b of the ratchet pawl 181, such that the engaging end 181b of ratchet pawl 181 that is opposite to the pivot end 181a becomes engaged with the groove 180b of the gear wheel 180, as shown in FIG. 2B, whereby the gear wheel 180 and its shaft in the shaft hole 180c can no longer rotate, thereby creating a permanent parking state.

It should be understood that after the engaging end 181b of the ratchet pawl 181 is engaged with the groove 180b of the gear wheel 180, the first cam 183 and the second cam 184 will remain in a state where the resilient element 185 is decompressed, as shown in FIG. 2B.

Furthermore, before the second cam 184 rotates, the baffle block 90 abuts against the first dead point P1 of the abutting surface S of the second cam 184 (as shown in FIG. 2A), but when the second cam 184 rotates (or swings) to a certain angle (such as 58 degree), the baffle block 90 would restrict the second cam 184 from rotating at the same direction (or swinging), at the second dead point P2 of the abutting surface S (as shown in FIG. 2B) which enables the shaft 182 and the first cam 183 to stop rotating, as such the cam set 18a stops the movement.

Also, as shown in FIG. 2C, when the engaging end 181b of the ratchet pawl 181 abuts against a tooth 180a of the gear wheel 180, the resilient element 185 absorbs the action energy from the cam set 18a, i.e., the first cam 183 and the second cam 184 compress the resilient element 185, to force the ratchet pawl 181 to stop the rotation of the gear wheel 180 and its shaft in the shaft hole 180c, thereby creating a temporary parking state. Meanwhile, the pillar 183a of the first cam 183 and the pillar 184a of the second cam 184 are not in contact. Thus, in the latter motion, if the gear wheel 180 rotates, the engaging end 181b of the ratchet pawl 181 follows the movement and slides in and engages with the groove 180b of the gear wheel 180 to create a permanent parking state. As such, by the resilient element 185 releasing the force of the cam set 18a, the first cam 183 and the second cam 184 release the resilient element 185, as shown in FIG. 2B.

If it is intended to disengage the parking state, the user can use the interlinkage mechanism (not shown) to rotate the shaft 182, along with the first cam 183 and the second cam 184 (as indicated by the inverse direction F in FIG. 2A), to enable the engaging end 181b of the ratchet pawl 181 opposing the pivot end 181a to rotate, thereby disengaging with the groove 180b of the gear wheel 180, as shown in FIG. 2A, to allow the gear wheel 180 and its shaft in the shaft hole 180c to rotate again, thereby disengaging the parking state. Meanwhile, the baffle block 90 is shifted to abut against the first dead point P1 from the second dead point P2 of the second cam 184, so as to restrict the second cam 184 to rotate in the same direction.

Hence, the parking mechanism 1 of the present disclosure features a cam set 18a as a driving means (a shaft 182 with two cams), to simplify the parking mechanism 1, and is easy to be manufactured and disassembled.

Moreover, the first cam 183 of the parking mechanism 1 features a contact surface U that is a continuous surface consisting of a first camber region A1, a planar region A2 and a second camber region A3 (as shown in FIG. 1D) in contact with the ratchet pawl 181 to allow the ratchet pawl 181 to smoothly and continuously move in relation to the first cam 183 to reduce the impact between the ratchet pawl 181 and the first cam 183, so as to facilitate the engagement of the ratchet pawl 181 with gear wheel 180, such that the parking mechanism 1 does not cause mechanism failure during the parking operation. In other words, if the contact surface of first cam 183 that is in contact with the ratchet pawl 181 is not continuous, the increased fiction between the ratchet pawl 181 and the first cam 183 may undesirably lead to mechanical failure of the parking mechanism 1.

Also, the cam set 18a of the parking mechanism 1 features a coordinated movement of the second cam 184 and baffle block 90 to control the motion of the cam set 18a in such a way that the second cam 184 may either abuts at the first dead point P1 or the second dead point P2 against the baffle block 90, the cam set 18a to be locked in these two states (clockwise or anticlockwise) and unable to continue the rotation motion.

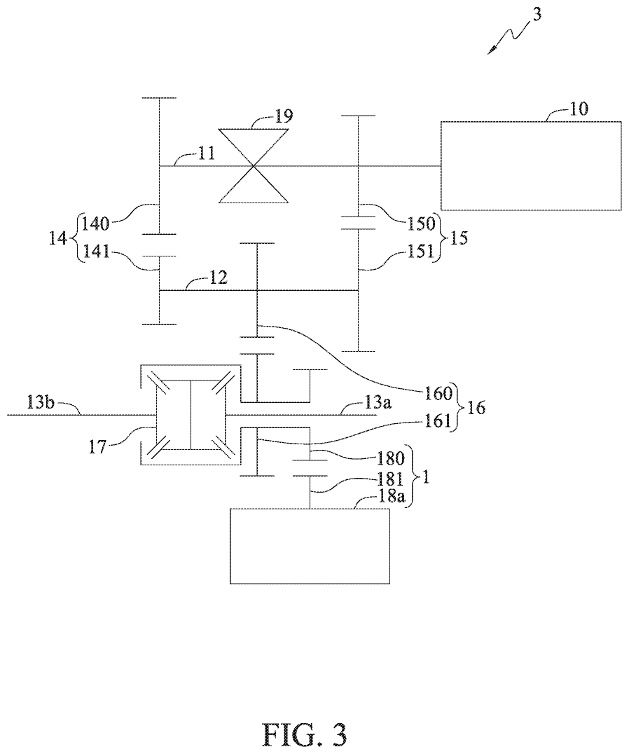

FIG. 3 is a schematic view depicting the framework of the gearbox in accordance with a second embodiment of the present disclosure.

As shown in FIG. 3, the gearbox 3 includes a first shaft 11, a second shaft 12, two third shaft 13a, 13b, a first gear set 14 disposed at the first shaft 11 and the second shaft 12, a second gear set 15 disposed at the first shaft 11 and the second shaft 12, a transmission mechanism 16 disposed at the second shaft 12 and the third shaft 13a, and parking mechanism 1 operated with the third shaft 13a.

In the present embodiment, the gearbox 3 may be further equipped with a baffle block 90, as shown in FIG. 1B.

The first shaft 11 functions as an input shaft, while the third shaft 13a, 13b functions as an output shaft.

In the present embodiment, the first shaft 11, the second shaft 12 and third shaft 13a, 13b are arranged horizontally in this order.

Further, the gearbox 3 may be further equipped with a differential 17, to respectively dispose the third shaft 13a, 13b on the opposing sides of the differential 17.

The first gear set 14 includes a first main gear wheel 140 pivotally coupled to the first shaft 11 and a first slave gear wheel 141 pivotally coupled to the second shaft 12. The first main gear wheel 140 engages with the first slave gear wheel 141, to drive the first shaft 11 to rotate the second shaft 12 via the first main gear wheel 140 and the first slave gear wheel 141.

The second gear set 15 includes a second main gear wheel 150 pivotally coupled to the first shaft 11 and a second slave gear wheel 151 pivotally coupled to the second shaft 12. The second main gear wheel 150 engages with the second slave gear wheel 151, to drive the first shaft 11 to rotate the second shaft 12 via the second main gear wheel 150 and the second slave gear wheel 151.

In the present embodiment, a synchronizer 19 is disposed between the first gear set 14 (the first main gear wheel 140) on the first shaft 11 and the second gear set 15 (the second main gear wheel 150) to simultaneously rotate the first shaft 11 and the second shaft 12.

The transmission mechanism 16 includes a primary transmission gear wheel 160 and a secondary gear wheel 161, and the primary transmission gear wheel 160 is pivotally coupled to the second shaft 12, while the secondary gear wheel 161 is pivotally coupled to the third shaft 13a on one side of the differential 17.

The parking mechanism 1 is shown in FIGS. 1A and 1D, wherein the ratchet pawl 181 is used for driving or stopping the third shafts 13a, 13b, and the cam set 18a is used for driving the ratchet pawl 181 to move.

In the present embodiment, the gear wheel 180 of the parking mechanism 1 is used for engaging with the ratchet pawl 181 and moving the third shafts 13a, 13b, such that the ratchet pawl 181 is engaged with third shafts 13a, 13b via the gear wheel 180. For example, the third shaft 13a on one side of the differential 17 is pivotally mounted to the shaft hole 180c of the gear wheel 180.

When the gearbox 3 is in operation, a motor 10 transmits the power to gearbox 3 via the first shaft 11, and the power is transmitted to the differential 17 through the first gear set 14, the second gear set 15, the second shaft 12 and the transmission mechanism 16, to drive the third shafts 13a, 13b. The gear wheel 180 would move in relation with the output shaft (or the third shaft 13a) of the gearbox 3. To enter the parking state, the user can use the interlinkage mechanism (not shown) to rotate the shaft 182 of the parking mechanism 1 (as shown in FIG. 1B), to permit the ratchet pawl 181 to engage with the gear wheel 180, such that both the gear wheel 180 and the third shaft 13a may no longer rotate, thereby stopping the third shafts 13a, 13b on the opposing side of the differential 17 to create a permanent parking state. If it is intended to disengage the parking state, the user can use the interlinkage mechanism (not shown) to rotate the shaft 182 and to disengage the ratchet pawl 181 from the gear wheel 180, so as to permit the gear wheel 180 and the third shaft 13a to rotate in response with transmission mechanism 16, thereby disengaging the parking state.

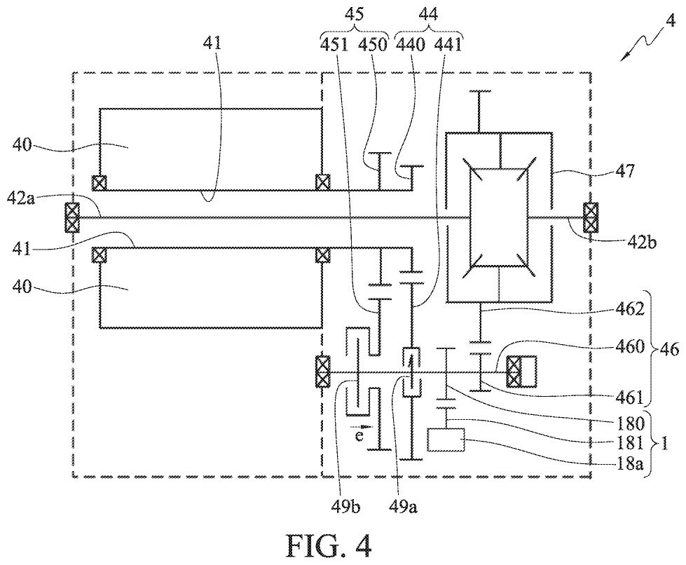

FIG. 4 is a schematic view depicting the framework of the gearbox in accordance with a third embodiment of the present disclosure.

As shown in FIG. 4, the gearbox 4 includes: a hollow motor 40 having a first shaft 41, second shafts 42a, 42b, a first gear set 44, a second gear set 45, a one direction thrust bearing 49a, clutch 49b, a transmission mechanism 46, and the parking mechanism 1.

In the present embodiment, the gearbox 4 may be equipped with a baffle block 90 as shown in FIG. 1B.

The first shaft 41 is a hollow shaft, functioning as an input shaft.

The second shafts 42a, 42b function as an output shaft, which are pivotally mounted to the first shaft 41.

In the present embodiment, the first shaft 41 and the second shaft 42a are pivotally coupled together in such a way that the first shaft 41 is an outer shaft while the second shaft 42a is an inner shaft.

The first gear set 44 is disposed at the first shaft 41, including a first main gear wheel 440 and a first slave gear wheel 441 which are engaged to each other, and pivotally coupled together. Through the first shaft 41, the first main gear wheel 440 drives the first slave gear wheel 441, and the power of the first slave gear wheel 441 is transmitted via the transmission mechanism 46.

In the present embodiment, the first gear set 44 may also include other transmission members such as chains, straps or other mechanical members, but not limited to a gear wheel.

The second gear set 45 is disposed at the first shaft 41 and consists of a second main gear wheel 450 and a second slave gear wheel 451 which are engaged to each other. The second main gear wheel 450 and the first shaft 41 are pivotally coupled with each other. The first shaft 41 drives the second main gear wheel 450 which in turn drives the second slave gear wheel 451, and the power of the second slave gear wheel 451 is transmitted via transmission mechanism 46.

In the present embodiment, the second gear set 45 also may include other transmission members, such as chains, straps or other mechanical members, but not limited to a gear wheel.

The one direction thrust bearing 49a is disposed at the position corresponding to the first slave gear wheel 441 of the first gear set 44 to facilitate movement of the first gear set 44 to drive the transmission mechanism 46.

The clutch 49b is a centrifugal clutch, disposed at the position corresponding to the second slave gear wheel 451 of the second gear set 45 to control the power transmission of the second gear set 45 to the transmission mechanism 46.

The transmission mechanism 46 is interlocked with the first gear set 44 or the second gear set 45.

In the present embodiment, the transmission mechanism 46 includes a transmission shaft 460 interlocked with the first gear set 44 or the second gear set 45, a first transmission gear wheel 461 on the transmission shaft 460 and a second transmission gear wheel 462 engaged with the first transmission gear wheel 461.

Moreover, the transmission shaft 460 is a rod, penetrating through the first transmission gear wheel 461, the first slave gear wheel 441 (and the single direction assembly 49a) of the first gear set 44, the second slave gear wheel 451 (and the clutch 49b) of the second gear set 45, to transmit the power generated from the first gear set 44 or the second gear set 45 via the transmission shaft 460.

In addition, the second transmission gear wheel 462 is engaged with a differential 47, to drive the differential 47, such that the transmission mechanism 46 can be designed as a shaft output (such as transmission shaft 460) or a gear wheel output (such as the second transmission gear wheel 462) according to requirements.

In addition, the second shafts 42a, 42b are disposed at the opposing sides of the differential 47 and the differential 47 interlinks with the transmission mechanism 46, to facilitate the transmission mechanism 46 to move the second shafts 42a, 42b via the differential 47.

The parking mechanism 1 is shown in FIGS. 1A and 1D, where the ratchet pawl 181 is interlocked with the transmission mechanism 46, while the cam set 18a is used for engaging with the ratchet pawl 181 to move.

In the present embodiment, the gear wheel 180 of the parking mechanism 1 is engaged with the ratchet pawl 181 to move the transmission shaft 460, and the ratchet pawl 181 is coupled to the transmission shaft 460 via the gear wheel 180. For example, the transmission shaft 460 is pivotally mounted in the shaft hole 180c of the gear wheel 180.

When the gearbox 4 is in operation, a motor 40 transmits the power to gearbox 4 via the first shaft 41, and the power is transmitted to the differential 47 through the first gear set 44, the second gear set 45, the transmission mechanism 46, to drive the second shafts 42a, 42b. The gear wheel 180 would move in relation with the transmission shaft 460. To enter the parking state, the user can use the interlinkage mechanism (not shown) to rotate the shaft 182 of the parking mechanism 1, to permit the ratchet pawl 181 to engage with the gear wheel 180, such that both the gear wheel 180 and the transmission shaft 460 may no longer rotate, thereby stopping the second shaft 42a, 42b on the differential 47 to create a permanent parking state. If it is intended to disengage the parking state, the user can use the interlinkage mechanism (not shown) to rotate the shaft 182 (as shown in FIG. 1B), to disengage the ratchet pawl 181 from the gear wheel 180, so as to permit the gear wheel 180 and the transmission shaft 460 to rotate, thereby disengaging the parking state.

When the first gear (low speed gear) of the gearbox 4 is engaged, the power transmission path of the gearbox 4 starts from the motor 40 to drive its first shaft 41, thereby driving the first main gear wheel 440 of the first gear set 44 to move the first slave gear wheel 441, then through the transmission shaft 460 of the transmission mechanism 46 in conjunction with the one direction thrust bearing 49a, followed by the first transmission gear wheel 461 and second transmission gear wheel 462 of the transmission mechanism 46, the differential 47 is driven to move the second shafts 42a, 42b. Meanwhile, since the clutch 49b is not engaged with the second slave gear wheel 451 of the second gear set 45, the second gear set 45 will not transmit power and is in idle.

When the second gear (high speed gear) of the gearbox 4 is engaged, the clutch 49b is engaged with the second slave gear wheel 451 of the second gear set 45 (as the clutch 49b moves towards and engages with the second slave gear wheel 451 of the second gear set 45), such that the power transmission path of the gearbox 4 starts from the motor 40 to drive its first shaft 41, thereby driving second main gear wheel 450 of the second gear set 45, to move the second slave gear wheel 451 of the second gear set 45, then through the transmission shaft 460 of the transmission mechanism 46 to drive the first transmission gear wheel 461 and second transmission gear wheel 462, to drive the differential 47 to move the second shafts 42a, 42b. Meanwhile, since the one direction thrust bearing 49a is not activated, the first gear set 44 will not transmit power and is in idle.

In summary, the gearbox and its parking mechanism disclosed by the present disclosure feature a cam set as a driving means to simplify the parking mechanism and are easy to be manufactured and disassembled.

Further, the contact surface of the first cam is divided as a first camber region, a planar region and a second camber region, to assist the ratchet pawl to make smooth movement in relation to the first cam, thereby reducing any impacts between the ratchet pawl and the first cam and not causing mechanical failure during the parking operation.

Moreover, the baffle block of the parking mechanism facilitates the control of the motion of the cam set (for example, radians).

In addition, the gearbox of the present disclosure can be adapted to moving devices. Through interchanging between clockwise and counterclockwise movement of the motor, the gearbox can be adapted to vehicles with or without reversing function, for example, cars, motorcycles, electric bicycles, wheelchairs or golf carts.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A parking mechanism, comprising:
a ratchet pawl; and
a cam set configured for driving the ratchet pawl, the cam set comprising a shaft, a first cam and a second cam pivotally engaged with the shaft,
wherein the shaft is configured for driving the first cam and the second cam to rotate.

2. The parking mechanism of claim 1, further comprising a gear wheel engaged with the ratchet pawl.

3. The parking mechanism of claim 1, wherein the first cam is in contact with the ratchet pawl.

4. The parking mechanism of claim 3, wherein the first cam is in contact with the ratchet pawl through a contact surface divided into a first camber region, a second camber region and a planar region coupling with the first camber region and the second camber region.

5. The parking mechanism of claim 4, wherein a ratio of the radius of the first camber region to the radius of the shaft is between 1 and 3, a ratio of a length of the planar region to the radius of the shaft is between 1 and 3, a ratio of the radius of the second camber region to the radius of the shaft is between 2 and 4.

6. The parking mechanism of claim 1, further comprising a resilient element disposed between the first cam and the second cam.

7. The parking mechanism of claim 6, wherein the second cam is engaged with one end of the shaft, with one end of the first cam abutting against a baffle plate of the second cam to enable the shaft to drive the first cam and the second cam and rotate simultaneously, and the first cam touches the ratchet pawl to create a parking state.

8. The parking mechanism of claim 6, wherein the resilient element is a compression spring.

9. A gearbox, comprising:
a main body equipped with a baffle block;
a ratchet pawl; and
a cam set configured for driving the ratchet pawl and comprising a shaft, a first cam and a second cam pivotally engaged with the shaft,
wherein the second cam abuts against the baffle block when the shaft drives the first cam and the second cam to rotate.

10. The gearbox of claim 9, wherein the second cam has a plane surface abutting against the baffle block.

11. The gearbox of claim 9, wherein the baffle block is configured for stopping the second cam to make the shaft stop rotating and the first cam stop rotating.

12. A gearbox, comprising:
a first shaft;
a second shaft;
a third shaft;
a first gear set disposed at the first shaft and the second shaft;
a second gear set disposed at the first shaft and the second shaft; and
a transmission mechanism disposed at the second shaft and the third shaft.

13. The gearbox of claim 12, further comprising a cam set and a ratchet pawl, wherein the cam set is configured to drive the ratchet pawl, and the ratchet pawl is configured to activate or stop the third shaft, and wherein the cam set comprises a shaft, a first cam and a second cam pivotally engaged with the shaft, and the shaft is configured to drive the first cam and the second cam to rotate.

14. The gearbox of claim 13, wherein the first shaft serves as an input shaft and the third shaft serves as an output shaft, and wherein the ratchet pawl is engaged with the third shaft via a gear wheel.

15. The gearbox of claim 13, further comprising a gear wheel engaged with the ratchet pawl and configured to move the third shaft.

16. The gearbox of claim 12, further comprising a synchronizer disposed between the first gear set on the first shaft and the second gear set.

17. The gearbox of claim 12, wherein the first shaft, the second shaft and the third shaft are arranged in parallel in a sequential order.

18. The gearbox of claim 12, further comprising a differential disposed at the third shaft.

19. A gearbox, comprising:
a first shaft;
a second shaft penetrating through the first shaft;
a first gear set disposed at the first shaft;
a second gear set disposed at the first shaft;
a one-direction thrust bearing disposed at the first gear set;
a clutch disposed at the second gear set;
a transmission mechanism interlocked with the first gear set or the second gear set;
a ratchet pawl interlocked with the transmission mechanism; and
a cam set configured for driving the ratchet pawl and comprising a shaft, a first cam and a second cam pivotally engaged with the shaft, wherein the shaft is configured to drive the first cam and the second cam to rotate.

20. The gearbox of claim 19, wherein the first shaft servers as an input shaft, and the second shaft serves as an output shaft.

21. The gearbox of claim 19, wherein the first shaft and the second shaft are coupled to each other in a way that the first shaft is the outer shaft while the second shaft is the inner shaft.

22. The gearbox of claim 19, further comprising a gear wheel engaged with the ratchet pawl and interlocked with the transmission mechanism.

23. The gearbox of claim 22, wherein the transmission mechanism comprises a transmission shaft interlocked with the first gear set or the second gear set and the gear wheel interlocked with the transmission shaft.

24. The gearbox of claim 19, further comprising a differential disposed at the second shaft and interlocked with the transmission mechanism.
